(19) United States
(12) Patent Application Publication
(10) Pub. No.: US 2002/0048212 A1
(43) Pub. Date: Apr. 25, 2002

(54) Concrete mix design systems and methods

(76) Inventors: Russell L. Hill, San Antonio, TX (US); Kevin D. Copeland, Helotes, TX (US); Karthik H. Obia, San Antonio, TX (US); Rodney C. Cunningham, San Antonio, TX (US); Troy W. Rodgers, Phoenix, AZ (US); Mary Ellen Rainwater, San Antonio, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/825,171

(22) Filed: Apr. 3, 2001

Related U.S. Application Data
(63) Continuation-in-part of application No. 09/648,436, filed on Aug. 25, 2000.
(60) Provisional application No. 60/150,982, filed on Aug. 25, 1999.

(51) Int. Cl. B28C 7/04

(52) U.S. Cl. 366/8; 366/16; 700/285

(57) ABSTRACT

A system for developing a concrete mix design that allows a user to input a set of initial design parameters (such as required average compressive strength) for the design, and to specify various design criteria (such as the cementitious materials, aggregates, and admixtures to be used in the design) using a series of input screens. The system then displays several key initial design parameters and design criteria within a design criteria and parameters summary that is displayed on a single “worksheet screen.” One or more of these criteria and/or parameters is displayed in user-modifiable format. Upon pressing a “calculate” button, the system displays an initial set of design specifications that meet the specified design parameters and criteria. The user may then modify any of the user-modifiable design parameters and criteria. In response such modifications, the system immediately generates an updated set of specifications that satisfies the revised criteria.

### CROSS-REFERENCE TO RELATED APPLICATIONS

This application is a continuation-in-part of non-provisional patent application Ser. No. 09/648,436, filed Aug. 25, 2000, which claimed priority to prior provisional patent application No. 60/150,982, which was filed Aug. 25, 1999. This application hereby incorporates both non-provisional application Ser. No. 09/648,436 and provisional patent application No. 60/150,982 by reference.

### FIELD OF THE INVENTION

The present invention relates to systems and methods for designing concrete mixes.

### BACKGROUND OF THE INVENTION

Concrete is a common building material that is commonly used as a key structural component in many different types of structures. Such structures include, for example, highways, bridges, dams, large buildings, sidewalks, and homes. Because the concrete is often used to support large amounts of weight, it is crucial that the concrete used in any given project be designed according to the design criteria specified for the project. Otherwise, the concrete could fail causing potentially catastrophic results.

The typical components, or “building blocks” for a given concrete mix include cement, water, fine and coarse aggregates, air, and certain chemical and mineral admixtures that influence the behavior of the mixture. When these components are blended together, the cement and water react to form a cementitious paste. If the concrete is mixed properly, this cementitious paste will form a bonding coat around each particle of the fine and coarse aggregates. As a result, as the concrete dries, the paste will harden and, thus, bind the aggregates together to form a substantially uniform, solid piece of material.

Concrete mixtures are generally defined in terms of the dry-volume ratios of cement and fine and coarse aggregates used in a particular mixture. For example, a 1:2:4 mixture comprises, by volume, one part of cement, two parts of fine aggregate, and four parts of coarse aggregate. These proportions are selected based on the requirements of the particular project for which the concrete is intended to be used. Thus, a user may select one mixture for a project requiring a very strong and durable concrete, and another mixture for a different project that requires only a moderately strong and durable concrete.

The amount of water that is added to a given concrete mixture typically ranges from about 1 to 1.5 times the volume of the cement used in the mixture. Generally speaking, the more water that is added to a particular concrete mix, the weaker the resulting hardened concrete will be. Thus, if a user requires very strong concrete, it is advantageous to include only the amount of water required to hydrate the cementitious materials and to provide the “water of convenience” necessary to properly place and finish the concrete mixture.

The required strength of a given concrete design is often specified as a “specified strength” (f¹c), which is the minimum strength that the concrete is required to consistently meet or exceed. In order to make sure that the concrete always meets or exceeds this “specified strength”, concrete mix designers often “overdesign” the concrete to include a safety factor that takes into account the variations that are commonly encountered in day-to-day production and testing. This over-designed strength is referred to as the “Required Average Strength” (f¹cr) of the concrete. Under American Concrete Institute (ACI) Standard 211, this “average strength must, of coarse, exceed the specific strength by a sufficient margin to keep the number of low tests within specific limits.”

There are several different ways to determine an appropriate f¹cr for a given concrete mix design. First, as specified in ACI 318 Building Code Requirements For Structural Concrete, Chapter 5, which is incorporated herein by reference, f¹cr may be determined through: (1) a “standard deviation method” that involves performing 30 strength tests on the concrete; (2) a “modified standard deviation method” that involves performing less than 30 tests on the concrete; or (3) if no strength tests have been performed on a particular design, f¹cr can be determined by using conversion Table 5.3.2.2 of Chapter 5 of the ACI 318 Building Code Requirements For Structural Concrete. This table specifies, for example, that, if a specified compressive strength is less than 3000 psi, the required average compressive strength should be f¹c plus 1000 psi.

Generally speaking, it is not desirable to use Table 5.3.2.2 to determine f¹cr, because values of f¹cr that are determined using this table generally include a much larger safety factor than necessary. Thus, for example, when designing a concrete having a specified strength (f¹c) of 2500 psi, one might derive a satisfactory f¹cr of 3100 psi for a given concrete mix design using the “standard deviation method” with 30 consecutive tests. However, one might derive an f¹cr of 3500 psi for this same design using Table 5.3.2.2. Because extra cement is usually required to increase the f¹cr of a given concrete mix, and because cement is relatively expensive, concrete mix designs with higher values of f¹cr are generally more expensive than mix designs with lower values of f¹cr. Thus, concrete mix designs for which f¹cr is determined using Table 5.3.2.2 are generally more expensive to produce than mix designs for which f¹cr is determined using the standard deviation method or the modified standard deviation method.

Because the standard deviation method and the modified standard deviation method both require that a mix design be tested to determine f¹cr, and because such testing is somewhat expensive and time consuming, it is desirable to keep records of such tests for any particular mix design for later use. Using the previous example, if a user determines by using the “standard deviation method” with 30 tests, that a given concrete mix design has an f¹cr of 3100 psi, it is useful for that user to record this information so that, if they use the same mix design at the same location in the future, they will be able to legitimately use an f¹cr of 3100 psi based upon their previous tests and thus alleviate the additional testing and expenses that would otherwise be required. Thus, it is advantageous for users to store information related to their various concrete mixes (such as the results of strength tests) for future reference.

One potential problem with relying on data stored for previous designs is that different concrete designs perform differently in different geographical regions. This is due to the fact that factors such as humidity level, temperature, aggregate quality and gradation, and cement chemistry can vary greatly from region to region. Thus, a given concrete mix design may have very different characteristics in one region than it does in another. For example, a particular concrete mix design that is developed and tested in the dry climate of Arizona may behave very differently in a very humid state, such as Florida.

Thus, in order to use data from a previous mix design to either produce concrete, or to develop a new mix design that is similar to the previous mix design, it is important to locate data for mix designs that were developed in the location in which the concrete or the new mix design will be used. This can be challenging in circumstances where a particular user (for example, a salesperson) has not developed mix designs for the geographical area in which the mix design will be used. In such cases, the user will have generally have no access to data from previous concrete mix designs that will be helpful in developing the current design.

In the past, individual salespeople of concrete-related products have tried to help their customers to perform these calculations by using homemade spreadsheet programs or preprinted forms. These spreadsheet programs are configured to develop a “recipe” for making a given concrete mix design that satisfies the design specifications for the concrete according to ACI standards. The printed forms also follow ACI standards.

There are many drawbacks to using such spreadsheet programs or printed forms. First, because such spreadsheets are created by individual salespeople with varying levels of computer programming and software testing experience, the reliability of these spreadsheets varies from salesperson to salesperson. Thus, for example, if a salesperson were to make a mistake in programming the spreadsheet to calculate a particular aspect of the concrete mix design, any concrete mix design created using the spreadsheet might not satisfy ACI standards. This could potentially cause any structures made with the concrete to collapse.

Another drawback is that the preprinted forms and spreadsheet programs assume that the user knows and understands how to use the various ACI guidelines and standards in a way that will truly satisfy all of the requirements set forth by the ACI. Such requirements include, but are not limited to, the amount of water to be used within a given concrete mix (based on the required strength of the concrete and coarse aggregate size), the minimum amount of cement required to be used within the concrete mix (based on the required strength of the concrete), and the air content that will be entrapped within the concrete (based on aggregate size).

A further drawback to using individual spreadsheet programs is that such programs are typically cumbersome to use. This is due to the fact that these spreadsheets generally require users to enter information into the various rows and columns of a grid that typically extends far beyond the contours of a standard computer display screen. Thus, users of these spreadsheets must scroll up and down, and to the left and right through many different “screens” within the same spreadsheet in order to enter all of the various design criteria for a particular design into the spreadsheet. Even when doing this, it is difficult to assure that the various design criteria have been entered into the appropriate cells within the spreadsheet.

Adding to the awkwardness of using these spreadsheets and preprinted forms is the fact that neither spreadsheets nor preprinted forms contain essential information that are needed to prepare mix designs that satisfy ACI Standards. Thus, when using these spreadsheets and forms to complete a design, users must reference separate charts and graphs that contain this information, and transfer information from these charts and graphs into the spreadsheet or preprinted form(s) being used to complete the design. Transferring information from these charts and graphs to the appropriate spreadsheet or form has the undesirable effect of increasing the likelihood that the concrete mix design will, as a result of inadvertent design errors, not comply with ACI Standards.

A further drawback to using prior spreadsheet programs is that the individual salespeople that use these spreadsheet programs typically store individual concrete design files on their personal computers and rarely create back-up copies of these files or share these designs with other salespeople. This results in two potential problems. First, the information acquired for each particular concrete design may only be accessed by those who have access to the salesperson's computer. Second, if a salesperson's computer were to be lost or suffer a major failure, all of the information related to all of the salesperson's mix designs could be lost—provided that the salesperson did not regularly back up his personal computer.

An even further drawback to using these spreadsheet programs or preprinted forms is that they generally do not allow a user to easily “tweak” a given concrete design to accommodate for the regional characteristics of the materials used in the design. For example, these spreadsheet programs and forms do not allow users to modify a concrete design to account for various dynamic characteristics of regional cementitious materials and aggregates. Such spreadsheets and forms are also typically not set up to provide the user with data regarding the effects that a particular admixture would have on a design.

Thus, there is a need in the art for a concrete mix design system that is configured to allow a user (such as a salesperson or other individual developing a concrete mix design): (1) to easily enter and revise mix design information; (2) to share mix design information with other users; (3) to conveniently make back up copies of any mix designs that are generated by the mix design software; (4) to modify an existing concrete mix design to account for the regional aspects of the materials used to make the design; (5) to record key characteristics of cementitious materials and aggregates that change over time; (6) to automatically reference the various information (obtained from various ACI charts and graphs) that is required to develop a design according to ACI Standards; and (7) to retrieve information about what effects a particular admixture, such as a water-reducing admixture, would have on a particular concrete design.

### SUMMARY OF THE INVENTION

The present invention seeks to provide an improved concrete mix design system that is configured to allow a user: (1) to easily enter and revise mix design information; (2) to share mix design information with other users; (3) to conveniently make back up copies of the mix designs that are generated by the mix design software; (4) to modify an existing concrete mix design to account for the regional aspects of the materials used to make the design; (5) to track key characteristics of various materials (such as cementitious materials and aggregates) that are used in the design; (6) to automatically reference the various information (obtained from various ACI charts and graphs) that is required to develop a design according to ACI Standards; and (7) to retrieve information about what effects a particular admixture, such as a water-reducing admixture, would have on the design. The present invention accomplishes this by providing a system and method for use in developing a concrete mix design that comprises computer-executable instructions for performing the steps of: (1) receiving one or more initial general design parameters; (2) receiving a first specific design criteria that specifies the cementitious materials to be used in the design; (3) receiving a second specific design criteria that specifies the aggregates to be used in the design; (4) receiving a third specific design criteria that specifies the admixtures to be used in the design; (5) displaying at least one of the initial design parameters, at least one of the second specific design criteria, and at least one of the third specific design criteria in a particular window; (6) displaying, within the particular window, an initial set of mix design specifications for making a discrete amount of concrete, the specifications satisfying both the initial design parameters, and the first, second, and third specific design criteria; (7) allowing a user to modify at least one of (a) the initial design parameters, (b) the first design criteria, (c) the second design criteria, or (d) the third design criteria; and (8) in response to the step of allowing a user to modify at least one of (a) the initial design parameters, (b) the first design criteria, (c) the second design criteria, or (d) the third design criteria, displaying a revised set of mix design specifications.

In a preferred embodiment of the invention, the revised set of mix design specifications satisfies any modifications made by the user to the initial design parameters, the first design criteria, the second design criteria, or the third criteria. Preferably, the system displays the revised set of mix design specifications in the particular window.

In a further preferred embodiment of the invention, the initial design parameters include one or more of the following: a maximum water to cement ratio, a minimum cementitious material content, a required slump, a specified air entrainment value, a required coarse aggregate size, and an indication of concrete exposure. The system is also preferably configured to perform the steps of generating a cost analysis report that includes the cost of preparing the discrete amount of concrete, and displaying the cost analysis report on a display screen. In addition, the system is preferably configured to calculate a cost of preparing the discrete amount of concrete by adding together: (1) the cost of any cement used in preparing the discrete amount of concrete; (2) the cost of any coarse aggregates used in preparing the discrete amount of concrete; (3) the cost of any fine aggregates used in preparing the discrete amount of concrete; (4) the cost of admixtures, air entraining agents, or fibers used in preparing the discrete amount of concrete; and (5) the cost of any additional cementitious/pozzolanic materials used in preparing the discrete amount of concrete.

A system according to a further preferred embodiment of the invention is configured for displaying an estimated concrete compressive strength that is calculated based on either a “performance” algorithm or an “optimized” algorithm. In this embodiment of the invention, when the estimated concrete compressive strength is calculated based on a “performance” algorithm, the weight of cementitious materials within the concrete is held constant, and the water content of the concrete is reduced as a result of admixture use. Furthermore, when the estimated concrete compressive strength is based on an “optimized” algorithm, the water-to-cement ratio of the cement is held constant, and the weight of cementitious materials within the concrete is reduced as a result of admixture use. In this embodiment of the invention, the system is configured to display an amount of cement saved as a result of admixture use when the estimated concrete compressive strength is based on the “optimized algorithm”.

A system according to yet another preferred embodiment of the invention is configured for receiving information from the user regarding one or more of the following: (1) the supplier of the cement to be used in the design; (2) the replacement rate of the fly ash (or other additional cementitious or pozzolanic materials) to be used in the design; (3) the class of the fly ash (or other additional cementitious or pozzolanic materials) to be used in the design; (4) the supplier of the fly ash (or other additional cementitious or pozzolanic materials) to be used in the design; (5) the specific gravity of the fly ash to be used in the design; (6) the supplier of the aggregate (or aggregates) to be used in the design; (7) the specific gravity of the aggregate (or aggregates) to be used in the design; (7) the percentage of the coarse aggregate (or coarse aggregates) to be used in the design; (8) the DRUW (Dry-Rodded-Unit-Weight) of the coarse aggregate (or coarse aggregates) to be used in the design; (9) the specific gravity of the fine aggregate(s) to be used in the design; (10) the percentage of the fine aggregate (or fine aggregates) to be used in the design; (11) the fineness modulus (FM) of the fine aggregate (or fine aggregates) to be used in the design; (12) the effects of the admixtures to be used in the design; (13) the dosage rates of the admixtures to be used in the design; and (14) the source of the water to be used in the design.

A system according to a further preferred embodiment of the invention is configured for performing the steps of: (1) allowing a user to search a database for a first set of design-related information related to a previous concrete mix; (2) displaying the first set of design-related information; (3) allowing the user to modify the set of design-related information to create a modified second set of design-related information; and (4) in response to the modification by the user of the first set of design-related information, displaying a set of concrete design specifications satisfying the modified second set of design-related information. The first set of design-related information preferably includes the results of strength tests performed on the previous concrete mix, and the composition of the previous concrete mix. In one embodiment of the invention, the previous mix may be designed by someone other than the user.

In a further preferred embodiment of the invention, the system is configured for allowing a user to add information to the database regarding new concrete mix designs. This information preferably includes region-specific information about the concrete mix such as the chemistry of the cement, aggregates, and water used in the design.

In one embodiment of the invention, the database is operable to store archived information that has been compiled by a third-party database provider (such as a producer of concrete-related products). This information may include information regarding a first concrete mix that was designed by a first concrete designer, and information regarding a second concrete mix that was designed by a second concrete designer. These first and second concrete designers may be, for example, customers of the third party database provider. The system is preferably configured for allowing a user to manually add information to the database regarding new concrete mix designs.

The claimed invention further includes a management method for use by a business that comprises the steps of: (1) creating an original version of a database that includes information relating to a plurality of concrete mix designs; (2) distributing at least part of the database to one or more users of a concrete mix design program; (3) receiving mix-design information from one or more users of said concrete mix design program, the mix-design information relating to a concrete mix; (4) producing an updated version of the database by adding the mix-design information to the database; and (5) distributing at least part of the updated version of the database to one or more users of said concrete mix design program. This management method preferably further includes the step of periodically distributing updated versions of the database to one or more users. In a preferred embodiment of the invention, at least one of the users of the concrete mix design program is a salesperson or a customer of the business.

Furthermore, the claimed invention includes a method of creating a concrete mix design for use by a business having a plurality of operating locations, in which the method includes the steps of: (1) creating an original version of a database that includes information relating to a plurality of concrete mix designs where at least one of the concrete mix designs has been designed for use at a first of the operating locations, and at least one of the concrete mix designs has been designed for use at a second of the operating locations; (2) allowing a user to search the database for a first set of design-related information related to a previous concrete mix; (3) displaying the set of design-related information; (4) allowing the user to modify the set of design-related information to create a modified second set of design-related information; and (5) after allowing the user to modify the design-related information, displaying a set of concrete design specifications satisfying the modified second set of design-related information. This inventive method preferably further comprises the steps of installing the database on a server at a central location, and allowing a user to access the database from a location that is remote from the central location.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system according to a preferred embodiment of the invention.

FIGS. 2A and 2B depict a flowchart that generally illustrates a concrete mix design module according to a preferred embodiment of the current invention.

FIG. 3 is a graphic illustration of a “worksheet” window according to the current invention after the “design parameter data entry area” of the window has been completed.

FIG. 4 is a graphic illustration of a “cementitious materials” window according to the current invention.

FIG. 5 is a graphic illustration of an “aggregates” window according to the current invention.

FIG. 6 is a graphic illustration of a “worksheet” window according to the current invention after the “cementitious materials” and “aggregates” windows have been completed.

FIG. 7 is a graphic illustration of an “admixtures” window according to the current invention.

FIG. 8 is a graphic illustration of a “worksheet” window according to the current invention after the “cementitious materials”, “aggregates”, and “admixtures” windows have been completed.

FIG. 9 is a graphic illustration of a “worksheet” window according to the current invention after the “cementitious materials”, “aggregates”, and “admixtures” windows have been completed, and the “calculate” button has been selected by the user.

FIG. 10 is a flowchart that generally illustrates an “optimization” sub-module according to a preferred embodiment of the current invention.

FIG. 11 is a flowchart that generally illustrates a “modify archived design” module according to a preferred embodiment of the current invention.

FIG. 12 is a graphic illustration of a “database comparison” window according to the current invention.

FIGS. 13A and 13B depict a flowchart that generally illustrates an inventive method of creating a concrete mix design for use by a business having a plurality of locations.

FIG. 14 is a flowchart that generally illustrates a method of management according to a preferred embodiment of the current invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. In addition, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

System Architecture

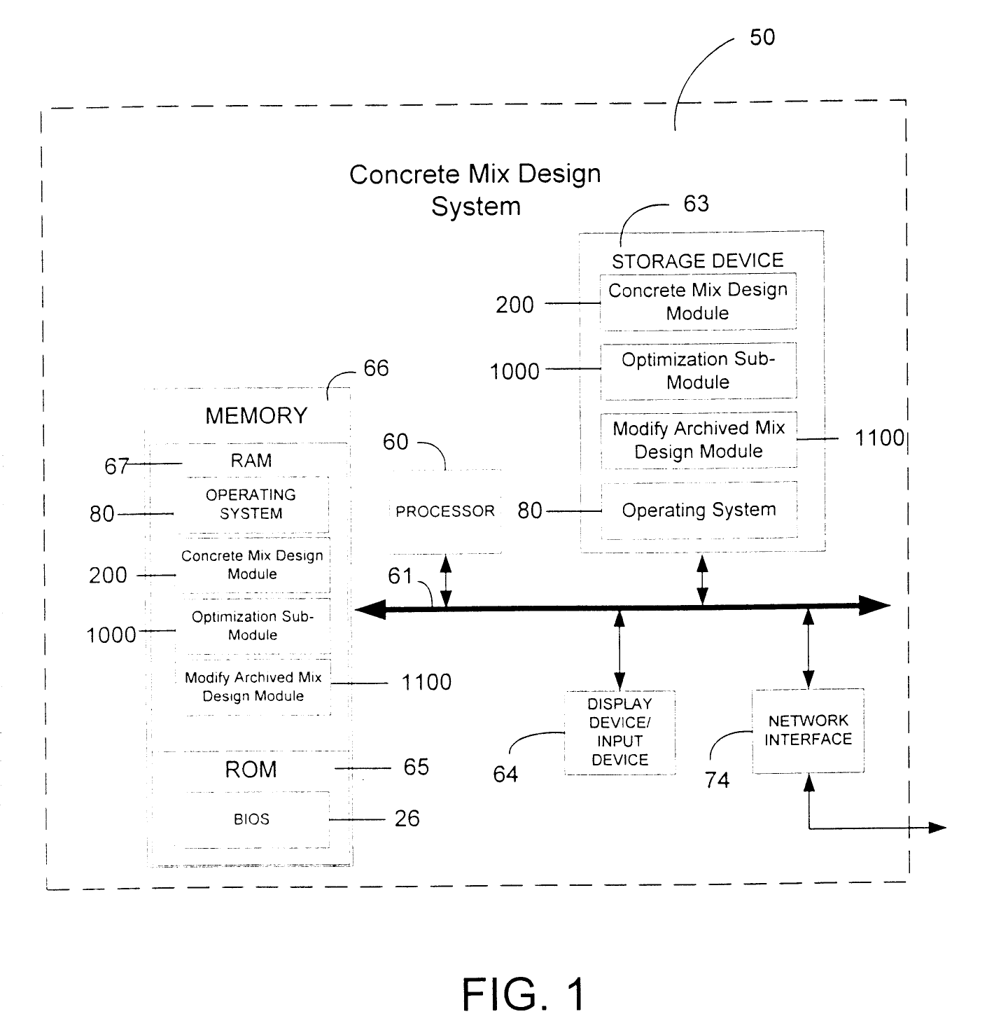

FIG. 1 shows a block diagram of one embodiment of a concrete mix design system 50 according to the present invention. The concrete mix design system 50 includes a processor 60 that communicates with other elements within the concrete mix design system 50 via a system interface or bus 61. Also included in the concrete mix design system 50 is a display device/input device 64 for receiving and displaying data. This display device/input device 64 may be, for example, a keyboard or pointing device that is used in combination with a monitor. The concrete mix design system 50 further includes memory 66, which preferably includes both read only memory (ROM) 65 and random access memory (RAM) 67. The server's ROM 65 is used to store a basic input/output system 26 (BIOS), containing the basic routines that help to transfer information between elements within the concrete mix design system 50.

In addition, the concrete mix design system 50 includes at least one storage device 63, such as a hard disk drive, a floppy disk drive, a CD ROM drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the concrete mix design system 50. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a concrete mix design module 200, an optimization sub-module 1000, and a “modify archived design” module 1100. The concrete mix design module 200, optimization sub-module 1000, and a “modify archived design” module 1100 control certain aspects of the operation of the concrete mix design system 50, as is described in more detail below, with the assistance of the processor 60 and an operating system 80.

Also located within the concrete mix design system 50 is a network interface 74, for interfacing and communicating with other elements of a computer network. It will be appreciated by one of ordinary skill in the art that one or more of the concrete mix design system 50 components may be located geographically remotely from other concrete mix design system 50 components. Furthermore, one or more of the components may be combined, and additional components performing functions described herein may be included in the concrete mix design system 50.

Brief Overview of a Preferred Embodiment

A preferred embodiment of the invention comprises a software package that is configured for use on a standard personal computer, such as an IBM-compatible personal computer with a Pentium IV microprocessor. This software package includes a Graphical User Interface (GUI) that is created using the Visual Basic programming language. This Graphical User Interface is configured to retrieve data from, and transmit data to, a Microsoft Access database. As will be understood to one of ordinary skill in the art, many other programming platforms may be used to implement the current invention.

The preferred embodiment of the invention contains a concrete mix design module 200, and a modify archived mix design programming module 1100. Generally speaking, the concrete mix design module 200 controls the general operation of the system as the system accepts information from the user and creates a concrete mix design based on this information. When executing the concrete mix design module 200, the system interfaces with the user through a series of information input screens and through a “worksheet” screen that is displayed, for example, within a display window on a computer monitor. The information input screens and the “worksheet” screen provide input boxes for receiving design-related information from the user. For example, these screens accept information from the user regarding the required design parameters of the design and the various materials to be used in the design.

After the user enters into the system the initial design parameters and information regarding the materials to be used in the design into the system, the system displays a completed “worksheet” screen that includes key portions of the various design-related data that the user entered on the previous input screens. Along with this information, the system displays a “calculate” button, which, when selected by the user, prompts the system to develop a concrete mix design that satisfies the design criteria specified by the user and any controlling ACI standards. After developing this concrete mix design, the system displays a formula for creating the design on the worksheet along with additional information related to the design, such as the estimated concrete compressive strength of concrete made according to the design. The system also visually indicates that several of the design criteria on the screen (such as, for example, slump, maximum aggregate size, and maximum water-to-cement ratio of the design) may be modified by the user.

Accordingly, a user may change any of the modifiable entries on the worksheet screen to see what effect changing that entry would have on the design. In response to any entry on the worksheet screen being modified, the system automatically develops and displays on the screen a new concrete mix design that meets the new design criteria. This allows a user to generate an initial design and then quickly refine the design by modifying various design criteria and instantly seeing the effect of the modifications.

The concrete mix design module preferably includes an optimization sub-module 1000 for calculating the estimated compressive strength of concrete that is produced using the current mix design. This optimization sub-module 1000 allows the system to calculate the estimated compressive strength of the design based on either a “performance” algorithm or an “optimized” algorithm.

When using the “performance” algorithm to calculate estimated compressive strength, the optimization sub-module calculates the estimate compressive strength by maintaining the weight of cementitious materials within the concrete constant, and reducing the water content of the concrete as a result of a water-reducing admixture use. This, in effect, allows the user to apply the beneficial effects of the water-reducing admixture toward lowering the water content of the concrete and, thus, making the concrete stronger. When using the “optimized” algorithm to calculate estimated compressive strength, the optimization sub-module calculates the estimated compressive strength by maintaining the water-to-cement ratio within the concrete constant and reducing the content of cementitious materials within the concrete as a result of admixture use. This effectively allows the user to apply the beneficial effects of the water-reducing admixture toward lowering the amount of cementitious materials needed to create a given amount of the concrete. This, in turn, reduces the cost associated with making the concrete.

Generally speaking, the system's “modify archived mix design” programming module 1100 allows the user to access various mix designs from a database of previous mix designs, modify various aspects of the mix design, and then analyze the mix design based upon the modified criteria. This allows a user to analyze different concrete design possibilities using archived mix designs as a starting point for the user's analysis. The “concrete mix design” module 200, the “optimization” sub-module 1000, the “modify archived mix design” module 1100, and several other aspects and features of a system according to the present invention are discussed in more detail below.

Concrete Mix Design Module

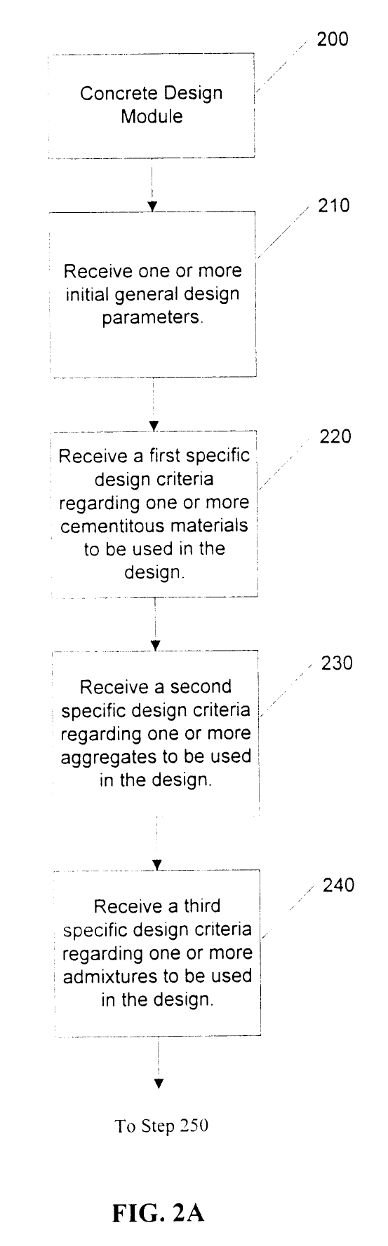

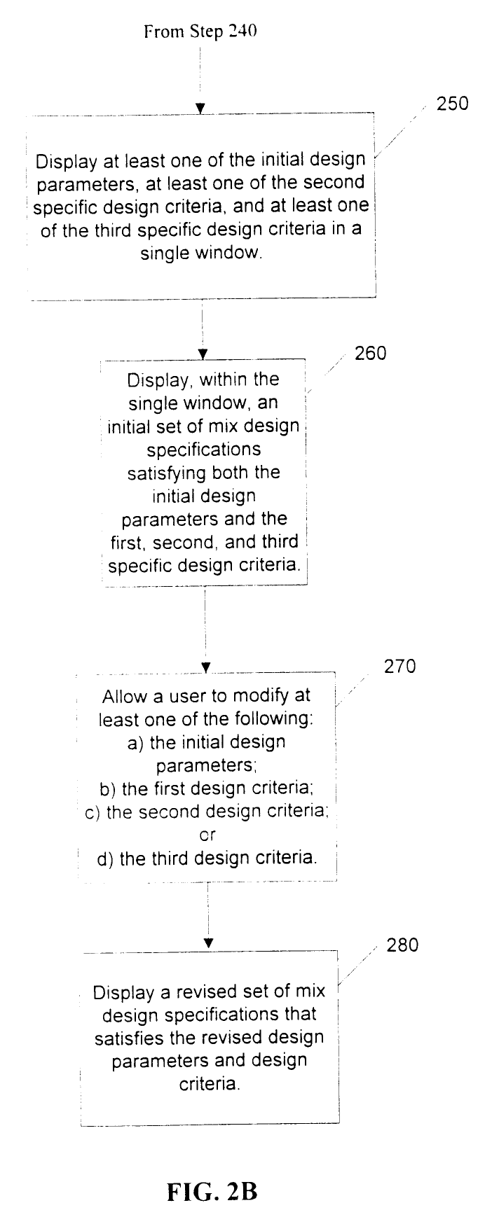

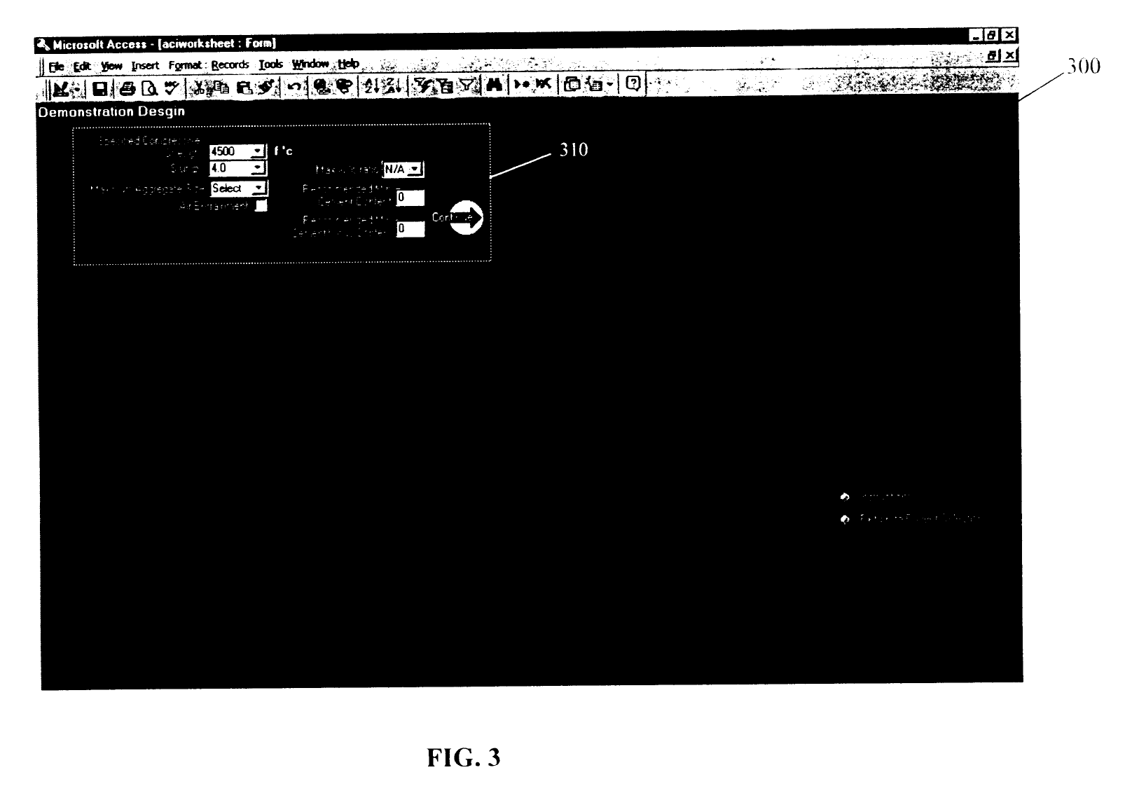

As noted above, the concrete mix design module 200 controls the general operation of the system as the system accepts information from a user and creates a mix design based on that information. FIG. 2 depicts the general flow of logical steps executed within this module. As shown in FIG. 2, at beginning step 210, the system receives one or more initial general design parameters from a user. In a preferred embodiment of the invention, the system does this using a particular window of a graphical user interface, such as the “worksheet” window 300 depicted in FIG. 3. As may be understood from this figure, the user may use this window to indicate, within a design parameter data entry area 310, the initial design parameters of the concrete mix design, such as: (1) specified compressive strength; (2) slump; (3) maximum aggregate size; (4) air entrainment; (5) the maximum water to cement ratio acceptable for the design; (6) recommended minimum cement content; and (7) recommended minimum cementitious content.

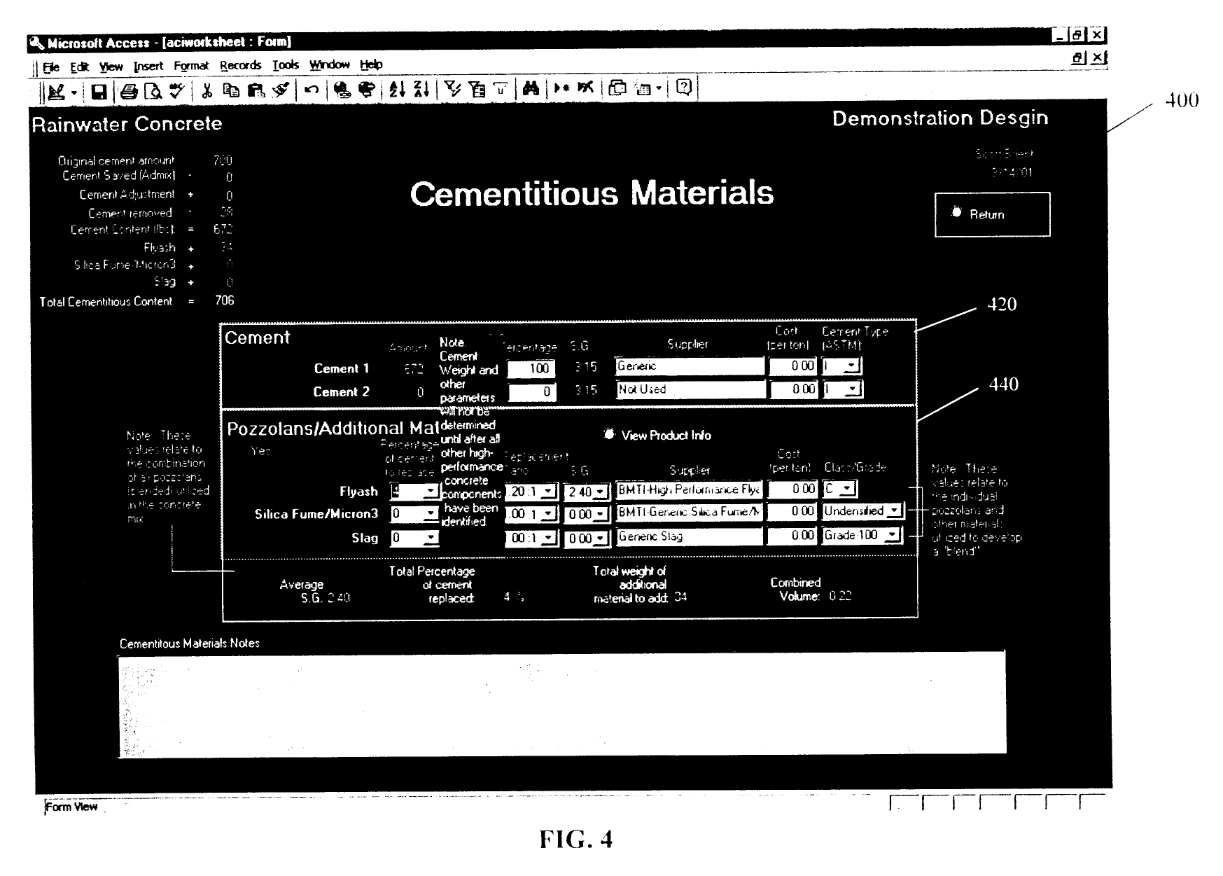

Next, the system proceeds to step 220, where it receives a first set of specific design criteria related to the cementitious materials to be used in the design. In a preferred embodiment of the invention, the system receives this first set of specific design criteria using a Cementitious Materials screen 400, such as the screen shown in FIG. 4. As may be understood from this figure, this screen contains a “Cement” data entry area 420, and an “Pozzolans/Additional Materials” data entry area 440. As shown in this figure, the cement data entry area 420 includes entry boxes for allowing the user to enter the amount, percentage, specific gravity, supplier, cost and type of up to two different types of cement to be used in the design. Similarly, the “Pozzolans/Additional Materials” data entry area 440 includes entry boxes for allowing the user to enter the following types of data related to any pozzolans or other cementitious materials other than concrete (such as fly ash, silica fume/Micron 3, and slag) that will be used in the design. This information includes the percentage of cement that each of the cementitious materials will replace, replacement ratio, specific gravity, supplier, cost, and the class or grade of the cementitious materials.

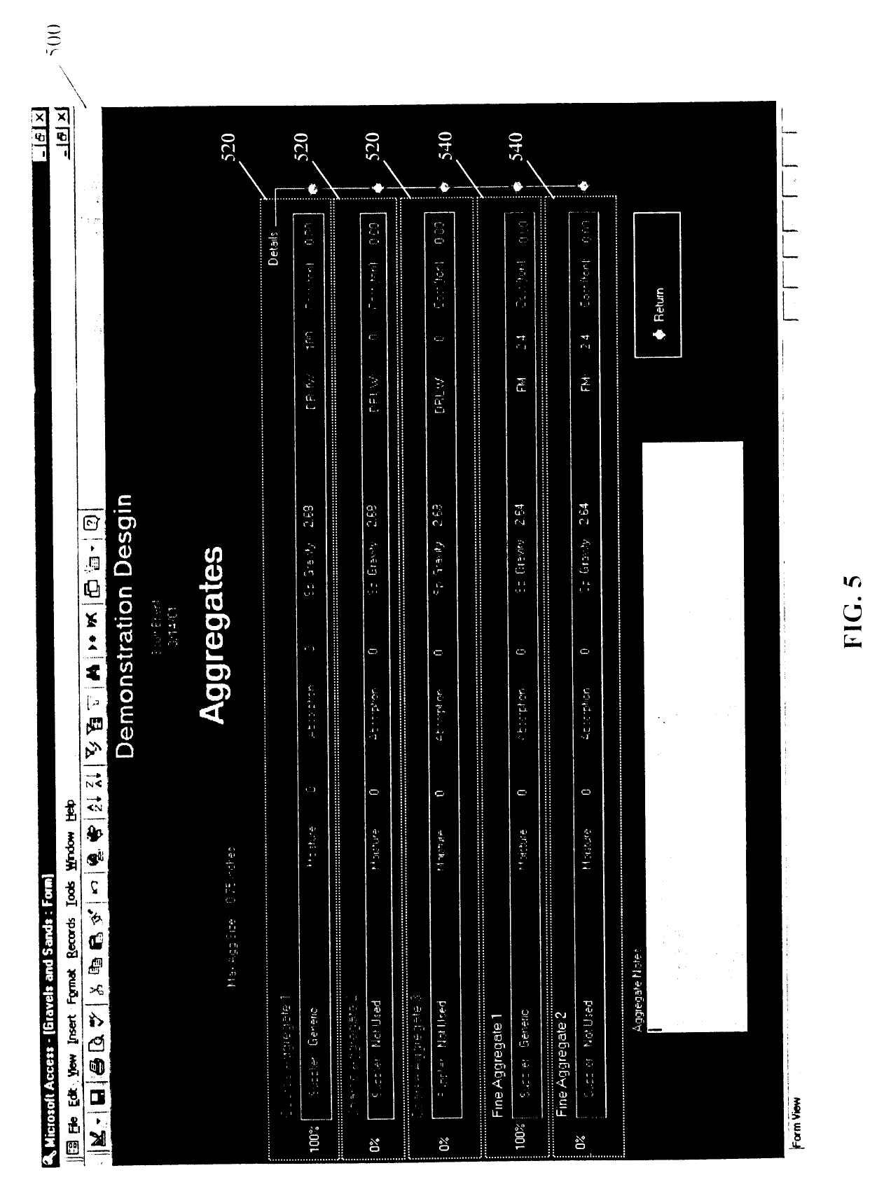

After receiving the necessary cementitious materials data, the system advances to step 230, where the system receives a second set of specific design criteria related to the aggregates to be used in the design. In a preferred embodiment of the invention, the system receives this second set of specific design criteria using an aggregates screen 500, such as the screen shown in FIG. 5. As may be understood from FIG. 5, this screen includes three coarse aggregate input areas 520, and three coarse aggregate input areas 540. Each coarse aggregate input area 520 provides a series of data input boxes in which the user may enter various information relating to a coarse aggregate to be used in the design. This data includes, for each coarse aggregate: supplier, moisture content, adsorption, specific gravity, DRUW, and cost. The data also includes the percentage of the total coarse aggregate content that is represented by the particular coarse aggregate.

Similarly, each fine aggregate input area 540 provides a series of data input boxes in which the user may enter various information relating to a fine aggregate to be used in the design. This data includes, for each fine aggregate: supplier, moisture content, absorption, specific gravity, fineness modulus (FM), and cost. The data also includes the percentage of the total fine aggregate content that is represented by the particular fine aggregate.

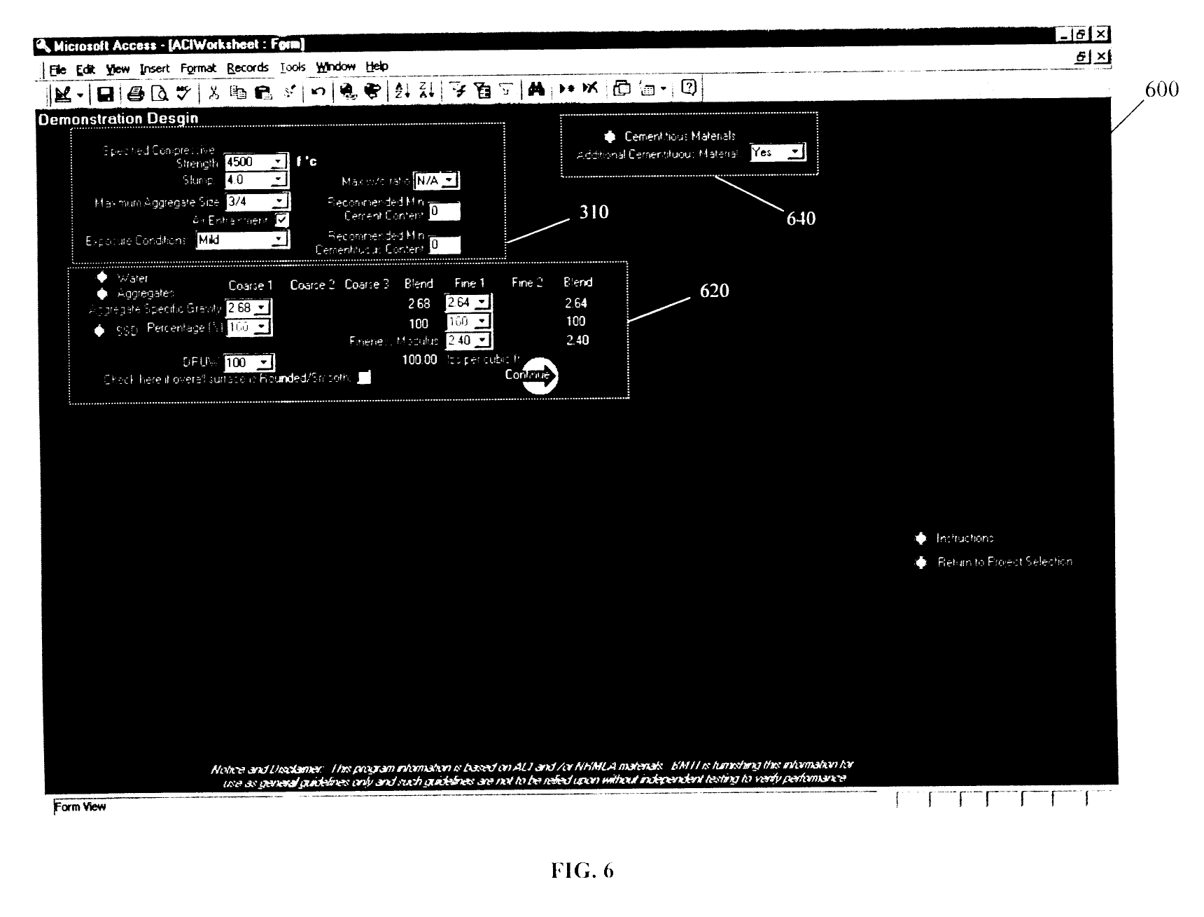

After the user enters the required information into the aggregates screen 500, the system displays an updated worksheet screen 600 (see FIG. 6) that displays: (1) the original design parameters within the design parameter data entry area 310; (2) selected aggregate data within the aggregate data area 620; and (3) data related to cementitious materials in the cementitious materials data area 640. In respect to FIG. 6, it is important to note that, although no specific design-related data is displayed within the cementitious materials data area 640 shown in FIG. 6, in an alternative embodiment of the invention, various data related to cementitious materials is displayed, in user-modifiable format, within this area 640.

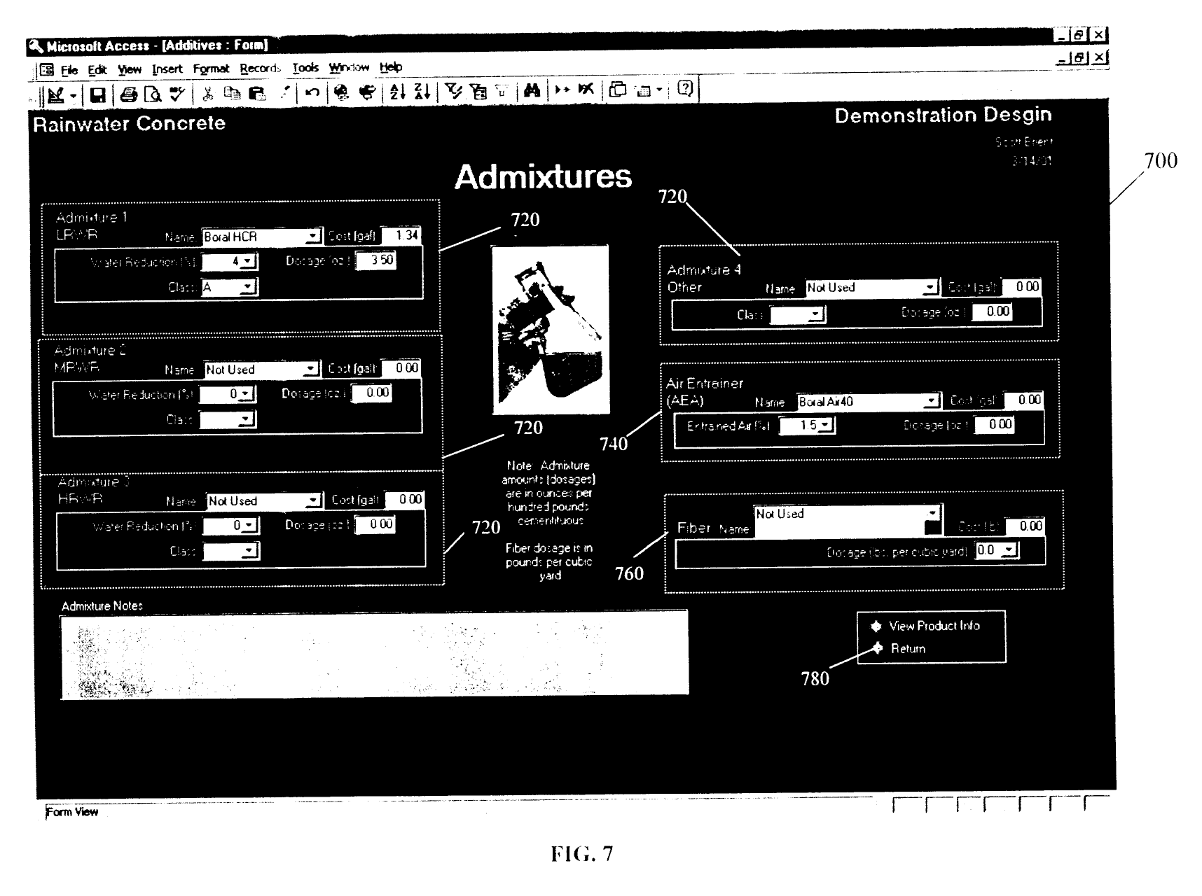

Next, the system proceeds to step 240, where it receives a third set of specific design criteria related to the admixtures to be used in the design. In a preferred embodiment of the invention, the system receives this information from the user via an admixture screen 700, such as the screen shown in FIG. 7. As may be understood from FIG. 7, such an admixture screen 700 preferably includes four admixture data input areas 720, an air entrainer input area 740, and a fiber input area 760. Each admixture data input area 720 includes data input boxes for receiving information relating to an admixture to be used in the design. Such data includes: (1) admixture name; (2) admixture cost; (3) the water reduction percentage associated with the admixture; (4) admixture dosage; and (5) admixture class. Similarly, each air entrainer data input area 740 includes data input boxes for receiving information relating to any air entrainer used in the design. Such information includes air entrainer name, air entrainer cost, entrained air percentage, and the dosage of the air entrainer. By the same token, each fiber data input area 760 includes data input boxes for receiving information relating to any fibers used in the design. Such information includes the name, cost and dosage of the fiber to be used in the design.

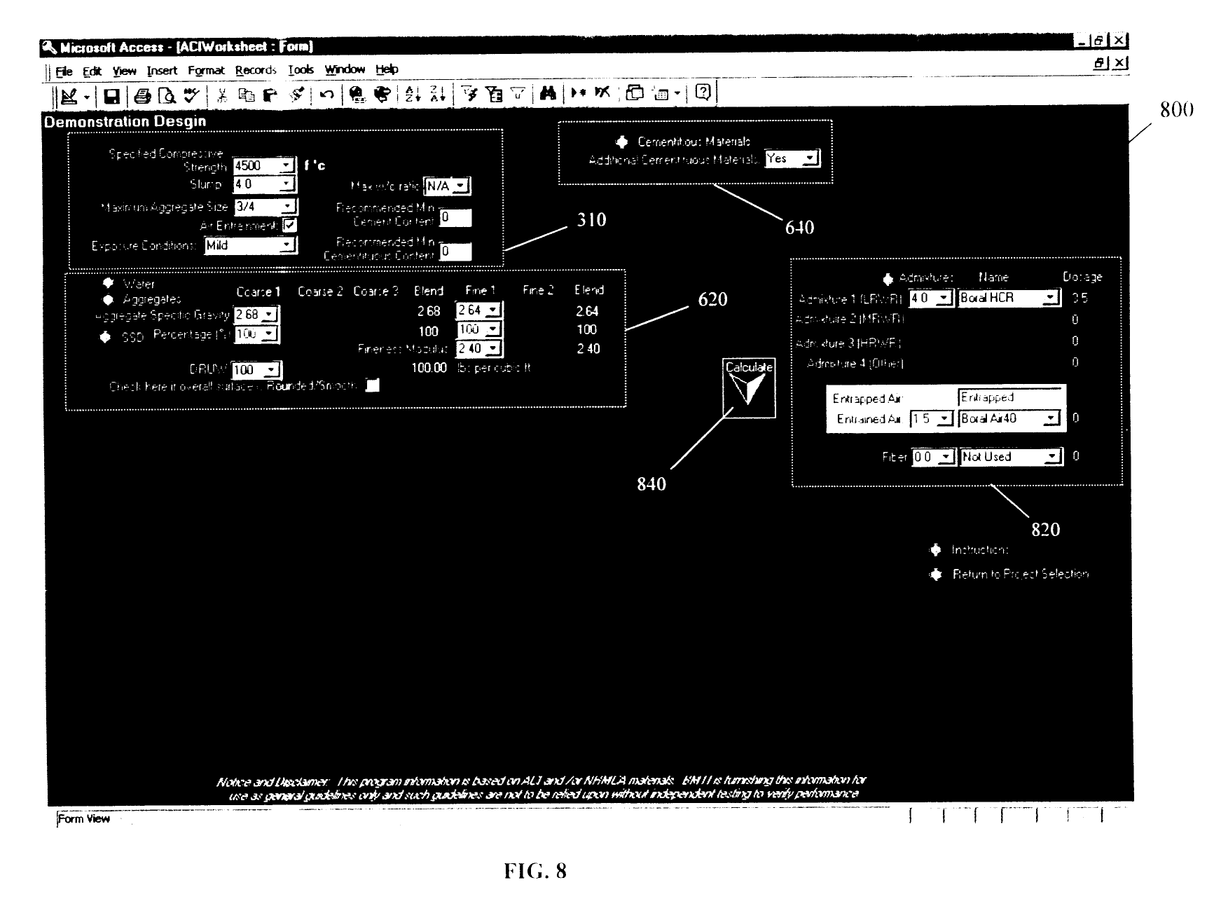

After the user has entered any appropriate admixture data using the admixture screen 700, the user selects a return key 780, and is returned to an updated version of the worksheet screen 800 as shown in FIG. 8. At this point, the worksheet displays: (1) the design parameter data entry area 310, which includes the various initial design parameters for the design; (2) a cementitious materials data area 640, which indicates whether additional cementitious materials other than concrete are used in the design; (3) an aggregate data area 620, which includes key data that was entered on the aggregate screen 600; and (4) an admixture data area 820, which includes key data that was entered on the admixture screen 700. Thus, at this point, the system has executed step 250 of the concrete mix design module 200, by displaying at least one of the initial design parameters, at least one of the second specific design criteria, and at least one of the third specific design criteria in a single window.

The design parameter data entry area 310 includes the following information for the design: (1) specified compressive strength; (2) slump; (3) maximum aggregate size; (4) whether there is air entrainment; (5) exposure conditions; (6) the maximum water to concrete ratio; (7) recommended minimum cement content; and (8) recommended minimum cementitious content. As may be understood from FIG. 8, each of these entries is presented in a user-modifiable format (such as a drop-down box) that allows the user to modify each of these entries as desired (with the exception of specified compressive strength).

The cementitious materials display area 640 includes a drop-down box that indicates whether additional cementitious material, other than cement, has been specified for the design. A user may use this drop-down box to specify whether any additional cementitious materials have been included in the design.

The aggregate display area 620 includes the following information in user-modifiable format: (1) the specific gravity for each coarse and fine aggregate; (2) the percentage of the total amount of coarse aggregates that each individual coarse aggregate represents (for example, this entry may indicate that a first coarse aggregate represents 100% of the total coarse aggregates); (3) the percentage of the total amount of fine aggregates that each individual fine aggregate represents; (4) the DRUW for each coarse aggregate; and (5) the FM (Fineness Modulus) for each fine aggregate. In a preferred embodiment of the invention, each of the above entries is displayed in a drop-box that the user may use to modify each of the entries. In addition, the system includes a check box that allows the user to indicate whether the overall surface of the aggregates is round or smooth.

In a preferred embodiment of the invention, in addition to the above-listed user-modifiable entries, the aggregate display area 620 also includes other types of information in a format that is modifiable by the user. For example, the moisture condition of the aggregates to be used is also displayed in the aggregate display area 620. This moisture condition, which is indicated as either Surface-Saturated-Dry (SSD) or Wet, effects the amount of “free” water used in the design. When the moisture condition of the aggregates is specified as “wet”, the system will require the user to enter information regarding the aggregate's moisture content and absorption.

In addition to the above user-modifiable entries, the aggregate display area 620 also displays other types of information in a format that is not modifiable by the user. This information includes the specific gravity for both the overall blend of coarse aggregates, and for the overall blend of fine aggregates used in the design. This information also includes the overall fineness modulus calculated for the blend of fine aggregates specified for the design. Each of these non-user-modifiable entries is automatically calculated by the system based upon information entered by the user.

The admixture display area 820 includes the following information in user-modifiable format: (1) the name of each admixture; (2) the water reduction associated with each admixture; (3) an indication as to whether the mix design contains entrapped air; (4) the entrained air percentage associated with any air entrainer used in the design; (5) the name of the air entrainer; (6) the dosage of any fiber used in the design; and (7) the type of fiber used. In addition, the admixture display area 820 includes, in non-user-modifiable format, the dosages associated with each admixture, the air entrainer, the fiber, and the various admixtures used in the mix design.

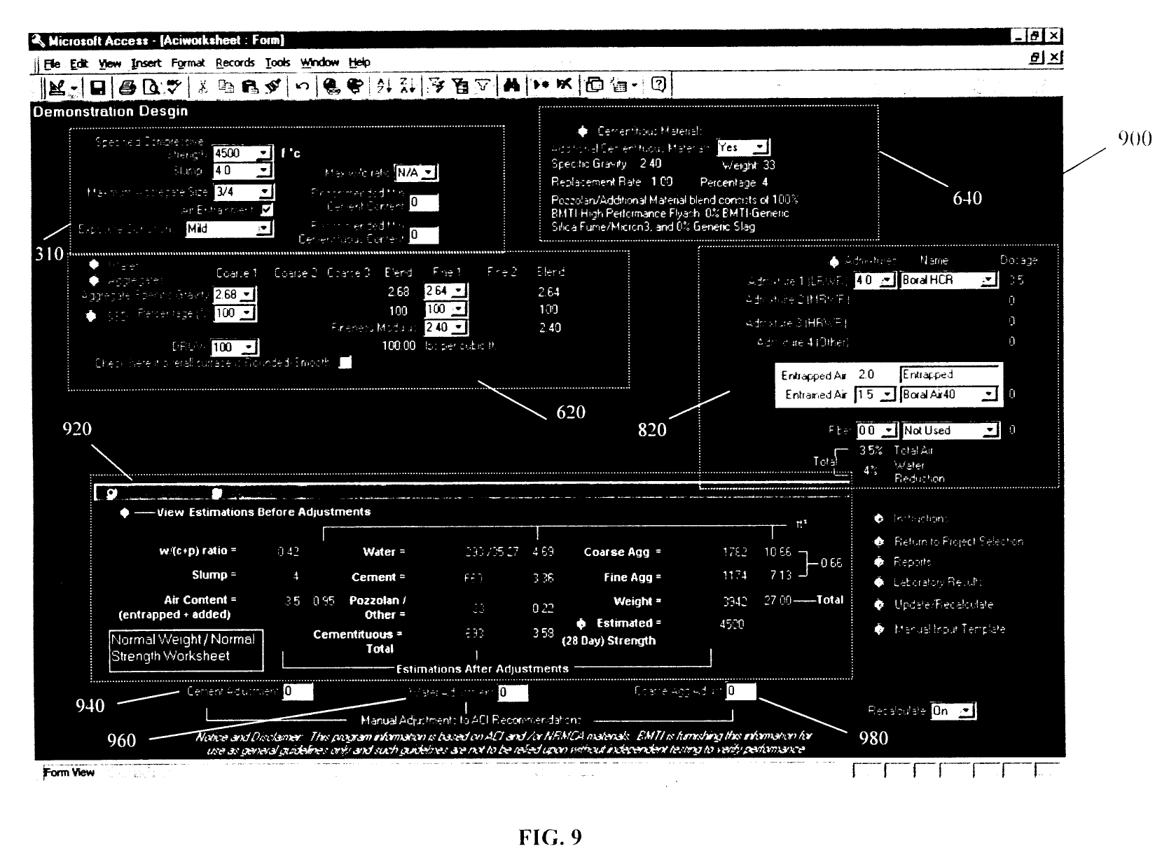

After the user reviews all of the information displayed on the worksheet screen, the user may instruct the system to derive a concrete mix design according to the information displayed on the worksheet screen by selecting a “calculate” button 840 that is displayed on the worksheet screen 800. After the user selects the “calculate” button 840, the system proceeds to step 260 of the concrete mix design module, where it displays, within a mix design box 920 that is displayed on the worksheet screen (or window), an initial set of mix design specifications that satisfies both the initial design parameters and the first, second, and third specific design criteria, as shown in FIG. 9.

More specifically, the system displays the following information within the mix design box: (1) w/(c+p) ratio; (2) slump; (3) air content; and (4) the estimated 28-day compressive strength of the concrete mix. The system also displays the weight and volume of each of the following: (1) the water used within the design; (2) the cement used within the design; (3) the pozzolan used within the design; (4) the total cementitious materials used within the design; (5) the coarse aggregates used within the design; (6) the fine aggregates used within the design; and (7) the total coarse and fine aggregates used within the design.

In addition, the system displays three data entry boxes 940, 960, 980 to the user in an “adjustments” area just below mix design box 920. These boxes include a cement adjustment box 940; a water adjustment box 960; and a coarse aggregate adjustment box 980. A user may use these boxes to adjust the weight of the cement, water, or coarse aggregates within the mixture to account for local conditions. For example, the user may specify that an additional amount of water should be added to the mix to account for local conditions.

After the system displays the mix design box 920 and the adjustment boxes 940, 960, 980 to the user, the system proceeds to step 270 of the concrete mix design module, where the system allows the user to adjust the design by modifying at least one of the following: (a) the initial design parameters; (b) the first design criteria; (c) the second design criteria; or (d) the third design criteria. The user may do this by changing the values displayed in any of the user-modifiable data boxes within the “worksheet” window (See FIG. 9). Immediately after the user makes such a change, the system re-calculates all of the data that is to be displayed on the worksheet screen 900, and then, at step 280 of the concrete mix design module 200, the system updates the worksheet screen 900 to display a set of specifications that satisfies the revised design parameters and design criteria.

For example, a user may change the slump of the mix design from 4.0 to 3.5. Doing so will cause the system to instantly derive a design that satisfies all of the original design criteria taking into account that the slump of the mix design is now 3.5 rather than 4.0. This functionality is advantageous because it allows the user to modify key components of the design and to immediately see what effects such modifications would have on the design. The user may, thus, create an initial design and then “tweak” the design to suit the user's specific needs by modifying various design criteria. After arriving at a suitable design using the dynamic capabilities of the “worksheet” screen, the user may then proceed to a “Lab Results” screen, where the user may enter the results of laboratory tests for the design into a database for later use.

Optimization Sub-module

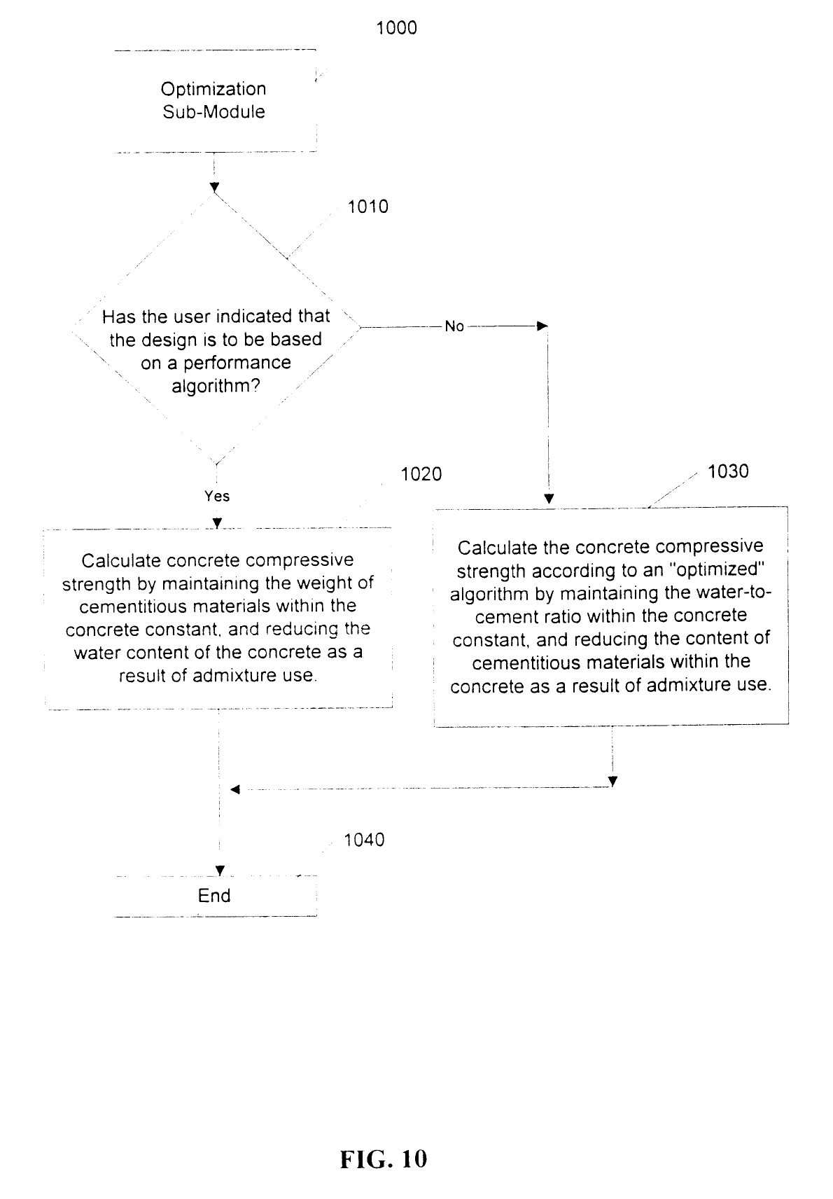

As noted above, in a preferred embodiment of the invention, the system includes an optimization sub-module 1000 for allowing a user to calculate a concrete design based upon either a “performance” algorithm, or an “optimized” algorithm. As shown in FIG. 10, when executing the optimization sub-module 1000, at beginning step 1010, the system determines whether the user has indicated that the design is to be based on a performance algorithm (for example, the system may check to see whether the user has selected an appropriate radio button or other graphic indicator on one of the design screens discussed above). If the user has indicated that the design is to be based on a performance algorithm, the optimization sub-module proceeds to step 1020 where it calculates the estimated compressive strength of the mix design by maintaining the weight of cementitious materials within the concrete mix design constant, and reducing the water content of the concrete as a result of water-reducing admixture use. This, in effect, allows the user to apply the beneficial effects of the water-reducing admixture toward lowering the water content of the mix design. As a result, when designing according to the “performance” algorithm, including a water-reducing admixture within the mix has the effect of increasing the compressive strength of concrete produced according to the mix design.

If the user has not indicated that the design is to be based on a “performance” design, after executing step 1010, the system proceeds to step 1030 where it calculates an estimated compressive strength of the mix design according to an “optimized” algorithm by maintaining the water-to-cement ratio within the concrete constant, and reducing the content of cementitious materials within the concrete as a result of admixture use. This effectively allows the user to apply the beneficial effects of the water-reducing admixture toward lowering the amount of cementitious materials needed to create a given amount of the mix design. This, in turn, reduces the costs associated with making the concrete. In a preferred embodiment of the invention, when a user calculates the estimated compressive strength based on an “optimized” algorithm, the system displays the amount of money saved as a result of the admixture use.

Database Functionality

As noted above, a system according to a preferred embodiment of the present invention is configured for saving concrete mix design information to a database, and for retrieving concrete mix design information from the database. This database is preferably comprised of two different types of data. The first type of data includes mix designs that were either developed by the user using the worksheet screen, as discussed above, or that have been manually entered by the user into the database on a separate “mix design entry” screen. The second type of data includes mix designs from an archive of mix designs that may or may not have been developed by the user, and that have preferably been compiled, maintained, and updated by a third party.

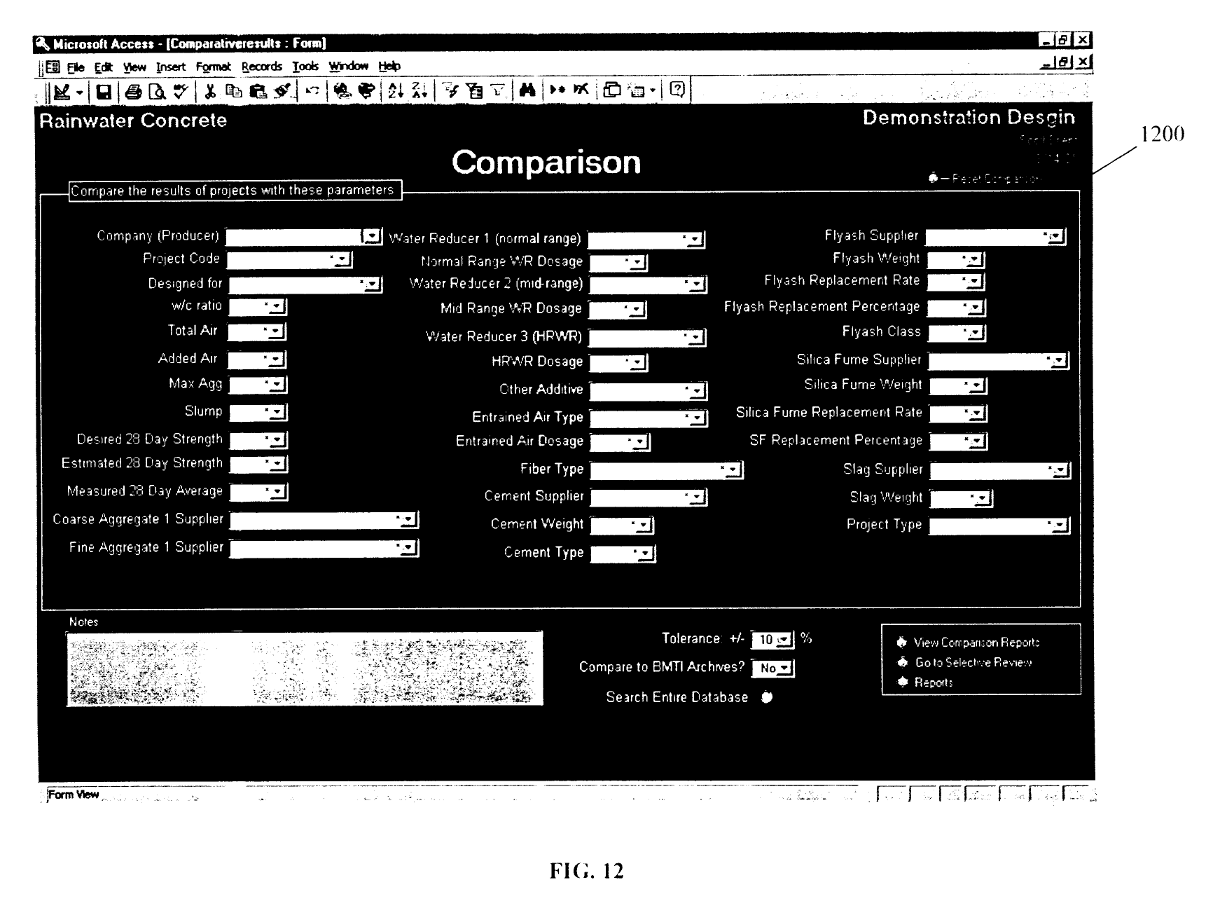

When using this database, a user may extract a previous mix design from the database (using a search screen such as the “comparison” screen 1200 shown in FIG. 12), and have the system compare the previous mix design with a current mix design based on, for example, the cost and other key features of the two concrete mix designs. This is useful in allowing the user to determine whether to use a current design for a given project, or to switch to a design that is similar to the previous design.

The database is also useful because it provides the user with numerous mix designs (and test information related to those designs) that the user can use as a starting point for creating a new design. This is especially useful in a situation where the user needs to design a concrete mix for use in a particular region, but has never designed any concrete mixes for that region. As a starting point, the user can search the database for designs from a particular region that have design characteristics that are similar to those required by the user. The user may then modify the design, as described above, to tailor the design to the user's needs and then save this design as a new design. Using the database in this way thus allows a user to arrive at a formal design by accessing and modifying concrete mix designs that the user did not develop. This can save the customer the time and expense that is normally required to develop a concrete design from scratch.

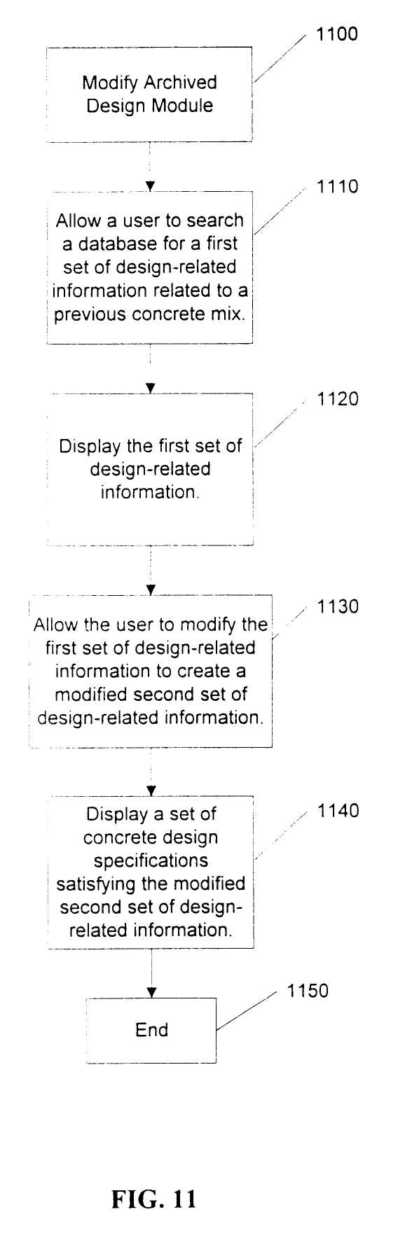

In a preferred embodiment of the invention, the system allows the user to locate an existing mix design within a database of mix designs and to modify the design using a “modify archived design” module, such as the module depicted in FIG. 11. As may be understood from this figure, the system begins at step 1110, where it allows a user to search a database for a first set of information that is related to a previous concrete mix design. As noted above, this previous concrete mix design may or may not have been developed by the user. The system then proceeds to step 1120 where it displays this first set of information to the user. The system preferably does this by displaying the information on the “worksheet” screen 900 as was described above in reference to FIG. 9.

After completing step 1120, at step 1130, the system allows the user to modify the first set of information to create a modified second set of design-related information. The system then proceeds to step 1140, where it displays a set of concrete design specifications that satisfy the modified second set of design-related information to the user.

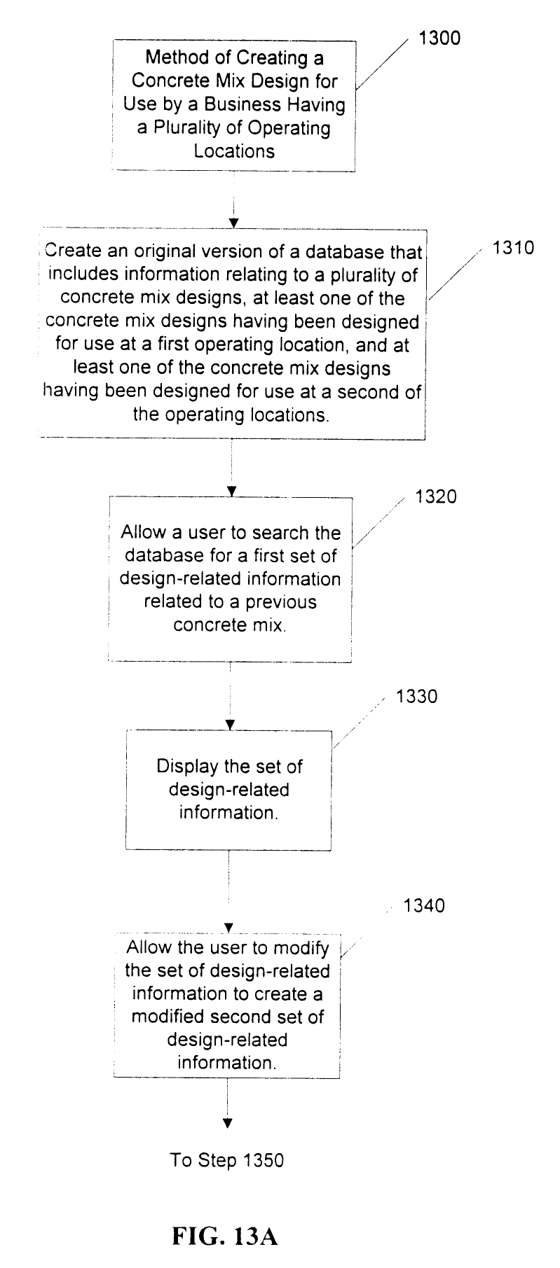

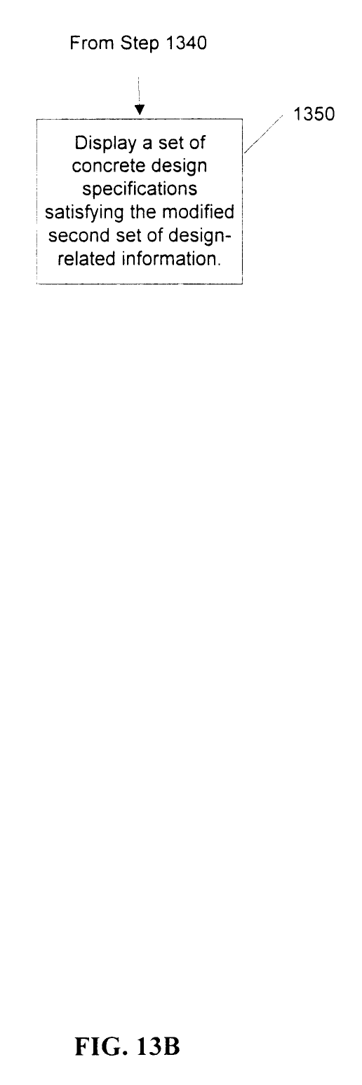

One example of how the database described above may be used by a business having several different operating locations is outlined in FIGS. 13A and 13B. As shown in these figures, at beginning step 1310, the business creates an original version of a database that includes information relating to a plurality of concrete mix designs. Preferably, at least one of these concrete mix designs has been designed for use at a first operating location of the business, and at least one of these concrete mix designs has been designed for use at a second operating location of the business. (For example, the database may include information relating to several concrete mix designs that were developed for use in Florida, and several concrete mix designs that were developed for use in Arizona.) Next, at step 1320, the system allows a user to search the database for a first set of design-related information related to a previous concrete mix. At step 1330, the system then displays this first set of design-related information to the user. The user may then save this set of design-related information as a new file.

Next, at step 1340, the system allows the user to modify this first set of design-related information as described above to create a modified second set of design-related information. The system then calculates a revised set of mix design information that satisfies the modified, second set of design-related information. Finally, at step 1350, the system displays the modified second set of design information to the user.

In one preferred embodiment of the invention detailed in FIG. 13, design information that has been developed at several of the business' different operating locations is stored in a database on a central server that may be accessed by one or more of the business' different operating locations. This allows the different operating locations to back up their various mix designs to a central location, and to share the mix design information with the business' other operating locations.

Mix Management Method

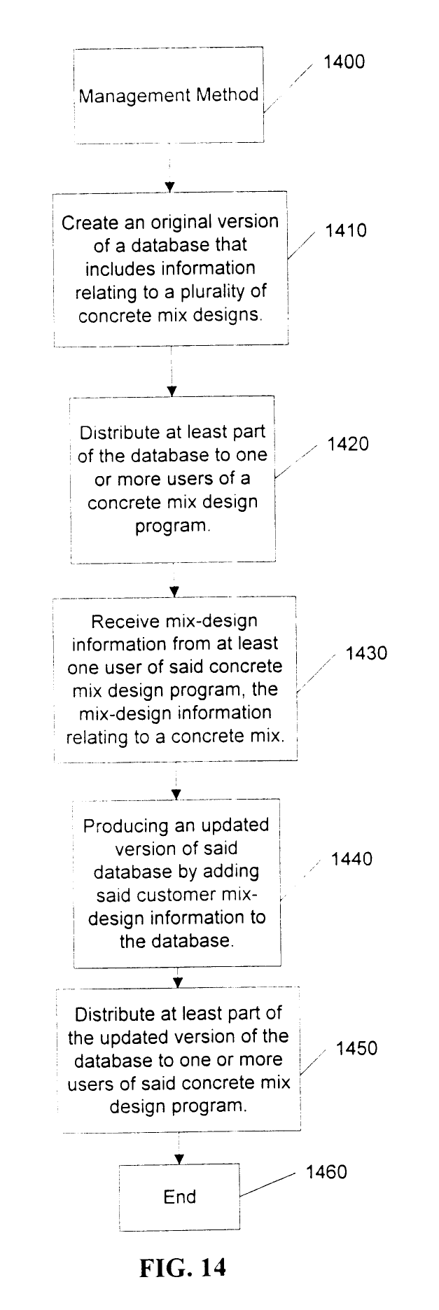

As noted above, in a preferred embodiment of the invention, the system includes a database of concrete mix designs that contains at least portions of a database containing archived concrete mix designs. In one embodiment of the invention, this archive of mix designs is developed and maintained by a producer of concrete-related products, and is used as part of an inventive mix management business method 1400 that is visually depicted in FIG. 14. As may be understood from this figure, at beginning step 1410 of this management method, the concrete product producer creates an original version of a database that includes information relating to a plurality of concrete mix designs. These mix designs may be developed, for example, by the concrete product producer or the concrete product producer's customers. The concrete product producer then proceeds to step 1420 where the concrete product producer distributes at least part of the database to one or more users of a concrete mix design program. Such users may include, for example, the concrete product producer's customers or salespeople. The concrete product producer may distribute the database by, for example, sending updated versions of the database to users of the concrete mix design program on periodic basis (for example, every six months). Alternatively, updated versions of the database may be periodically emailed to users of the concrete mix design program, or posted to an internet site for downloading by users of the concrete mix design program.

Next, at step 1430, the concrete product producer receives new concrete mix design information from at least one user of the concrete mix design program that relates to a concrete mix design. (Preferably, this concrete mix design has been designed by the user.) After receiving this information, at step 1440, the concrete product producer produces an updated version of the database by adding the new mix-design information to the database. Finally, at step 1450, the concrete product producer then distributes the updated version of the database to one or more users of the concrete mix design program.

The advantages of the above management method are extensive. First, this management method allows the concrete product producer to keep in close contact with their customers and salespeople, and to provide their customers and salespeople with updated information regarding the concrete product producer's products. This method also allows the concrete product producer to provide beneficial information to it's customers, which may result in increased customer loyalty. In addition, this method allows the concrete product producer to track the performance of its various concrete-related products within various regions of the world. For example, the concrete product producer could use this information to analyze how a certain admixture performs in the dry climate of Arizona versus the relatively humid climate of Florida by simply analyzing mix design information that it had received from customers and salespeople that had used that particular admixture in Arizona and Florida. This provides the concrete product producer with the advantage of obtaining region-specific information without having to perform tests within each region of the country.

It is important to note that, while the above management method is described above as applied in the concrete product business, the management method could also be applied in other types of business.

Reporting Capabilities

As will be understood by one of ordinary skill in the art, the fact that the current system uses a relational database to store information will allow users to develop any of a variety of reports that summarize the data regarding the various designs that are stored within the database. For example, one report may include a cost-analysis report that includes the cost of preparing a discrete amount of concrete according to a particular concrete design. Such a report may calculate this cost by, for example, adding together the cost of any cement, aggregates, and admixtures used in the concrete mix design.

Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-readable medium for use in developing a concrete mix design, said computer-readable medium comprising computer-executable instructions for performing the steps of:
1) receiving one or more initial general design parameters;
2) receiving a first specific design criteria regarding one or more cementitious materials to be used in said design;
3) receiving a second specific design criteria regarding one or more aggregates to be used in said design;
4) receiving a third specific design criteria regarding one or more admixtures to be used in said design;
5) displaying at least one of said initial design parameters, at least one of said second specific design criteria, and at least one of said third specific design criteria in a single window;
6) displaying, within said single window, an initial set of mix design specifications for making a discrete amount of concrete, said specifications satisfying both said initial design parameters and said first, second, and third specific design criteria;
7) allowing a user to modify at least one of:
a) said initial design parameters,
b) said first design criteria,
c) said second design criteria, or
d) said third design criteria; and
8) in response to said step 7 of allowing said user to modify at least one of said initial design parameters, said first design criteria, said second design criteria, or said third design criteria, displaying a revised set of mix design specifications.

2. The computer-readable medium of claim 1, wherein said revised set of mix design specifications satisfies any modifications that were made to said initial design parameters, said first design criteria, said second design criteria, or said third design criteria during said step 7.

3. The computer-readable medium of claim 1, wherein said step 8 of displaying a revised set of mix design specifications comprises displaying said revised set of mix design specifications in said single window.

4. The computer-readable medium of claim 1, wherein said initial design parameters comprise a maximum water to cement ratio.

5. The computer-readable medium of claim 4, wherein said initial design parameters comprise a minimum cementitious material content.

6. The computer-readable medium of claim 5, wherein said initial design parameters comprise a required slump.

7. The computer-readable medium of claim 5, wherein said initial design parameters comprise a specified air entrainment value.

8. The computer-readable medium of claim 5, wherein said initial design parameters comprise a required coarse aggregate size.

9. The computer-readable medium of claim 5, wherein said initial design parameters comprise an indication of exposure.

10. The computer-readable medium of claim 1, further comprising computer-executable instructions for performing the steps of:
generating a cost analysis report that includes a cost of preparing said discrete amount of concrete; and
displaying said cost analysis report on a display screen.

11. The computer-readable medium of claim 1, further comprising computer-executable instructions for performing the step of:
calculating a cost of preparing said discrete amount of concrete, said step of calculating comprising the step of adding together:
(a) the cost of any cement used in preparing said discrete amount of concrete;
(b) the cost of any coarse aggregates used in preparing said discrete amount of concrete;
(c) the cost of any fine aggregates used in preparing said discrete amount of concrete;
(d) the cost of any admixtures used in preparing said discrete amount of concrete; and
(e) the cost of any cementitious or pozzolanic material, other than cement, used in preparing said discrete amount of concrete.

12. The computer-readable medium of claim 1, further comprising computer-executable instructions for performing the step of:
displaying an estimated concrete compressive strength that is calculated based on either a “performance” algorithm or an “optimized” algorithm, and wherein:
(a) when said estimated concrete compressive strength is calculated based on a “performance” algorithm, a weight of cementitious materials within the concrete is held constant, and a water content of the concrete is reduced as a result of admixture use; and
(b) when said estimated concrete compressive strength is based on an “optimized” algorithm, a water-to-cement ratio of said cement is held constant, and a weight of cementitious materials within the concrete is reduced as a result of admixture use.

13. The computer-readable medium of claim 12, further comprising computer-executable instructions for performing the step of:
when said estimated concrete compressive strength is based on said “optimized algorithm”, displaying an amount of cement saved as a result of admixture use.

14. The computer-readable medium of claim 1, further comprising computer-executable instructions for performing the step of receiving information from said user regarding the supplier of the cement to be used in said design.

15. The computer-readable medium of claim 1, further comprising computer-executable instructions for performing the step of receiving information from said user regarding the replacement rate of an amount of fly ash to be used in said design.

16. The computer-readable medium of claim 1, further comprising computer-executable instructions for performing the step of receiving information from said user regarding the class of an amount of fly ash to be used in said design.

17. The computer-readable medium of claim 1, further comprising computer-executable instructions for performing the step of receiving information from said user regarding the supplier of an amount of fly ash to be used in said design.

18. The computer-readable medium of claim 1, further comprising computer-executable instructions for performing the step of receiving information from said user regarding the specific gravity of an amount of fly ash to be used in said design.

19. The computer-readable medium of claim 1, further comprising computer-executable instructions for performing the step of receiving information from said user regarding a specific gravity of a coarse aggregate to be used in said design.

20. The computer-readable medium of claim 1, further comprising computer-executable instructions for performing the step of receiving information from said user regarding a percentage of a coarse aggregate to be used in said design.

21. The computer-readable medium of claim 1, further comprising computer-executable instructions for performing the step of receiving information from said user regarding a DRUW of a coarse aggregate to be used in said design.

22. The computer-readable medium of claim 1, further comprising computer-executable instructions for performing the step of receiving information from said user regarding a specific gravity of a fine aggregate to be used in said design.

23. The computer-readable medium of claim 1, further comprising computer-executable instructions for performing the step of receiving information from said user regarding the percentage of the fine aggregate to be used in said design.

24. The computer-readable medium of claim 1, further comprising computer-executable instructions for performing the step of receiving information from said user regarding a fineness modulus (FM) of a fine aggregate to be used in said design.

25. The computer-readable medium of claim 1, further comprising computer-executable instructions for performing the step of receiving information from said user regarding a moisture condition of an aggregate to be used in said design.

26. The computer-readable medium of claim 25, further comprising computer-executable instructions for performing the step of, in response to receiving information from said user that indicates that said moisture condition of said aggregate is wet, receiving information from said user regarding moisture content and absorption properties of said aggregate.

27. The computer-readable medium of claim 1, further comprising computer-executable instructions for performing the step of receiving information from said user regarding the effects of the admixtures to be used in said design.

28. The computer-readable medium of claim 1, further comprising computer-executable instructions for performing the step of receiving information from said user regarding a dosage rate of an admixture to be used in said design.

29. The computer-readable medium of claim 1, further comprising computer-executable instructions for performing the step of receiving information from said user regarding the source of water to be used in said design.

30. A system for generating a concrete mix design, said system comprising:
A) a central processing unit;
B) a memory coupled to said central processing unit;
C) a display screen, said display screen coupled to said central processing unit, said display screen being operable to display a graphical user interface, said graphical user interface being operable to perform the steps of:
1) receiving one or more initial design parameters;
2) receiving a first specific design criteria regarding one or more cementitious materials to be used in said design;
3) receiving a second specific design criteria regarding one or more aggregates to be used in said design;
4) receiving a third specific design criteria that specifies one or more admixtures to be used in said design;
5) displaying at least one of said initial design parameters, at least one of said second specific design criteria, and at least one of said third specific design criteria in a single window;
6) displaying, within said single window, an initial set of mix design specifications for making a discrete amount of concrete, said specifications satisfying both said initial design parameters and said first, second, and third specific design criteria;
7) allowing a user to modify at least one of:
a) said initial design parameters,
b) said first design criteria,
c) said second design criteria, or
d) said third design criteria; and
8) in response to said step of allowing said user to modify at least one of said initial design parameters, said first design criteria, said second design criteria, or said third design criteria, displaying a revised set of mix design specifications.

31. The computer-readable medium of claim 30, wherein said revised set of mix design specifications satisfies any modifications that were made to said initial design parameters, said first design criteria, said second design criteria, or said third design criteria during said step 7.

32. The computer-readable medium of claim 30, wherein said step 8 of displaying a revised set of mix design specifications comprises displaying said revised set of mix design specifications in said single window.

33. The system of claim 31, wherein said initial design parameters comprise a maximum water-to-cement ratio.

34. The system of claim 32, wherein said initial design parameters comprise a minimum cementitious material content.

35. The system of claim 34, wherein said initial design parameters comprise a required slump.

36. The system of claim 34, wherein said initial design parameters comprise a specified air entrainment value.

37. The system of claim 34, wherein said initial design parameters comprise a required coarse aggregate size.

38. The system of claim 34, wherein said initial design parameters comprise an indication of exposure.

39. The system of claim 32, wherein said graphical user interface is further operable to perform the steps of:
generating a cost analysis report that includes a cost of preparing said discrete amount of concrete; and
displaying said cost analysis report on a display screen.

40. The system of claim 30, wherein said graphical user interface is further operable to perform the step of:
calculating a cost of preparing said discrete amount of concrete, said step of calculating comprising the step of adding together:
(a) the cost of any cementitious materials used in preparing said discrete amount of concrete;
(b) the cost of any coarse aggregates used in preparing said discrete amount of concrete;
(c) the cost of any fine aggregates used in preparing said discrete amount of concrete; and
(d) the cost of any admixtures used in preparing said discrete amount of concrete.

41. The system of claim 30, wherein said graphical user interface is further operable to perform the step of:
displaying an estimated concrete compressive strength that is calculated based on either a “performance” algorithm or an “optimized” algorithm, and wherein:
(a) when said estimated concrete compressive strength is calculated based on a “performance” algorithm, a weight of cementitious materials within the concrete is held constant, and a water content of the concrete is reduced as a result of admixture use; and
(b) when said estimated concrete compressive strength is based on an “optimized” algorithm, a water-to-cement ratio of said cement is held constant, and a weight of cementitious materials within the concrete is reduced as a result of admixture use.

42. The system of claim 30, wherein said graphical user interface is further operable to perform the step of:
when said estimated concrete compressive strength is based on said “optimized algorithm”, displaying an amount of cement saved as a result of admixture use.

43. A method for generating a concrete mix design, said method comprising the steps of:
1) receiving one or more initial design parameters;
2) receiving a first specific design criteria regarding one or more cementitious materials to be used in said design;
3) receiving a second specific design criteria regarding one or more aggregates to be used in said design;
4) receiving a third specific design criteria that specifies one or more admixtures to be used in said design;
5) displaying at least one of said initial design parameters, at least one of said second specific design criteria, and at least one of said third specific design criteria in a single window;
6) displaying, within said a single window, an initial set of mix design specifications for making a discrete amount of concrete, said specifications satisfying both said initial design parameters and said first, second, and third specific design criteria;
7) allowing a user to modify at least one of:
a) said initial design parameters,
b) said first design criteria,
c) said second design criteria, or
d) said third design criteria;
8) after said step 7 of allowing a user to modify at least one of said initial design parameters, said first design criteria, said second design criteria, or said third design criteria, displaying a revised set of mix design specifications satisfying any modifications to said first design criteria, said second design criteria, or said third design criteria that were made by said user during said step 7.

44. The computer-readable medium of claim 43, wherein said step 8 of displaying a revised set of mix design specifications comprises displaying said revised set of mix design specifications in said single window.

45. The method of claim 43, wherein said initial design parameters comprise a maximum water-to-cement ratio.

46. The method of claim 45, wherein said initial design parameters comprise a minimum cementitious material content.

47. The method of claim 46, wherein said initial design parameters comprise a required slump.

48. The method of claim 46, wherein said initial design parameters comprise a specified air entrainment value.

49. The method of claim 46, wherein said initial design parameters comprise a required coarse aggregate size.

50. The method of claim 46, wherein said initial design parameters comprise an indication of exposure.

51. The method of claim 43, further including the steps of:
generating a cost analysis report that includes a cost of preparing said discrete amount of concrete; and
displaying said cost analysis report on a display screen.

52. The method of claim 43, further including the step of:
calculating a cost of preparing said discrete amount of concrete, said step of calculating comprising the step of adding together:
(a) the cost of any cementitious materials used in preparing said discrete amount of concrete;
(b) the cost of any coarse aggregates used in preparing said discrete amount of concrete; and
(c) the cost of any fine aggregates used in preparing said discrete amount of concrete.

53. The method of claim 43, further including the step of:
displaying an estimated concrete compressive strength that is calculated based on either a “performance” algorithm or an “optimized” algorithm, and wherein:
(a) when said estimated concrete compressive strength is calculated based on a “performance” algorithm, a weight of cementitious materials within the concrete is held constant, and a water content of the concrete is reduced as a result of admixture use; and
(b) when said estimated concrete compressive strength is based on an “optimized” algorithm, a water-to-cement ratio of said cement is held constant, and a weight of cementitious materials within the concrete is reduced as a result of admixture use.

54. The method of claim 43, further including the step of:
when said estimated concrete compressive strength is based on said “optimized algorithm”, displaying an amount of cement saved as a result of admixture use.

55. A computer-readable medium for use in designing a concrete mix, said computer-readable medium comprising computer-executable instructions for performing, within a single display window, the steps of:
allowing a user to search a database for a first set of design-related information related to a previous concrete mix;
displaying said first set of design-related information;
allowing said user to modify said set of design-related information to create a modified second set of design-related information; and
in response to said modification by said user of said design-related information, displaying a set of concrete design specifications satisfying said modified second set of design-related information.

56. The computer-readable medium of claim 55, wherein said first set of design-related information includes the results of strength tests performed on said previous concrete mix.

57. The computer-readable medium of claim 55, wherein said first set of design-related information includes a composition of said previous concrete mix.

58. The computer-readable medium of claim 55, wherein said previous mix was designed by someone other than said user.

59. The computer-readable medium of claim 55, further comprising computer-executable instructions for performing the step of allowing a user to add information to said database regarding new concrete mix designs.

60. The computer-readable medium of claim 55, wherein the said first set of design-related information includes region-specific information about said previous concrete mix.

61. The computer-readable medium of claim 60, wherein said region-specific information is selected from a group consisting of: cement chemistry, aggregate characteristics, and water chemistry.

62. The computer-readable medium of claim 55, wherein said database is operable to store archived information that has been compiled by a third-party database provider.

63. The computer-readable medium of claim 62, wherein said archived information includes information regarding a first concrete mix that was designed by a first concrete designer, and information regarding a second concrete mix that was designed by a second concrete designer.

64. The computer-readable medium of claim 63, wherein said first and second concrete designers are customers of said third party database provider.

65. The computer-readable medium of claim 63, further comprising computer-executable instructions for performing the step of allowing a user to add information to said database regarding new concrete mix designs.

66. The computer-readable medium of claim 65, wherein said computer-executable instructions for performing said step of allowing a user to add information to said database regarding new concrete mix designs are operable to allow a user to manually add said information to said database.

67. A management method for use by a business, said management method comprising the steps of:
creating an original version of a database that includes information relating to a plurality of concrete mix designs;
distributing at least part of said original version of said database to one or more users of a concrete mix design program;
receiving mix-design information from at least one user of said concrete mix design program, said mix-design information relating to a concrete mix;
producing an updated version of said database by adding said mix-design information to said database; and
distributing at least a part of said updated version of said database to one or more users of said concrete mix design program.

68. The management method of claim 67, wherein at least one of said users of said concrete mix design program is a customer of said business.

69. The management method of claim 67, wherein at least one of said users of said concrete mix design program is a salesperson.

70. The management method of claim 67, further including the step of periodically distributing updated versions of said database to one or more users of said concrete mix design program.

71. A method of creating a concrete mix design for use by a business having a plurality of operating locations, said method comprising the steps of:
creating an original version of a database that includes information relating to a plurality of concrete mix designs, at least one of said concrete mix designs having been designed for use at a first of said operating locations, and at least one of said concrete mix designs having been designed for use at a second of said operating locations;
allowing a user to search said database for a first set of design-related information related to a previous concrete mix;
displaying said set of design-related information;
allowing said user to modify said set of design-related information to create a modified second set of design-related information; and
after allowing said user to modify said design-related information, displaying a set of concrete design specifications satisfying said modified second set of design-related information.

72. The method of creating a concrete mix design of claim 69, further comprising the steps of:
installing said database on a server at a central location; and allowing a user to access said database from a location that is remote from said central location.

73. A computer-readable medium for use in developing a concrete mix design, said computer-readable medium comprising computer-executable instructions for performing the steps of:
1) receiving one or more initial general design parameters;
2) receiving a first specific design criteria that specifies one or more cementitious materials to be used in said design;
3) receiving a second specific design criteria that specifies one or more aggregates to be used in said design;
4) receiving a third specific design criteria that specifies one or more admixtures to be used in said design;
5) receiving an indication as to whether a “performance” algorithm or an “optimized” algorithm should be used to calculate an estimated compressive strength of concrete produced using said design;
6) displaying an estimated concrete compressive strength that is calculated based on either a “performance” algorithm or an “optimized” algorithm, and wherein:
a) when said estimated concrete compressive strength is calculated based on a “performance” algorithm, a weight of cementitious materials within the concrete is held constant, and a water content of the concrete is reduced as a result of admixture use; and
b) when said estimated concrete compressive strength is based on an “optimized” algorithm, a water-to-cement ratio of said cement is held constant, and a weight of cementitious materials within the concrete is reduced as a result of admixture use.
